(19) United States
(12) Patent Application Publication
(10) Pub. No.: US 2026/0304217 A1
(43) Pub. Date: Oct. 1, 2026

(54) CONGESTION CONTROL SCHEME IN PACKET SPRAY NETWORK

(71) Applicant: HUAWEI TECHNOLOGIES CO., LTD., SHENZHEN (CN)

(72) Inventors: Junyi ZHANG, Kanata (CA); REN Shoushou, Kanata (CA); Ali MUNIR, Kanata (CA); Mahmoud Mohamed BAHNASY, Kanata (CA)

(73) Assignee: HUAWEI TECHNOLOGIES CO., LTD., SHENZHEN (CN)

(21) Appl. No.: 19/097,251

(22) Filed: Apr. 1, 2025

(51) Int. Cl. H04W 28/02; H04W 28/06

(52) U.S. Cl. CPC H04W 28/0289; H04W 28/06

(57) ABSTRACT

Methods, apparatus, and systems are provided for packet-level and lossy load-balancing in a communication network, especially for artificial intelligence applications. Embodiments are generally directed towards regulating data transmissions according to the amount of data that has been sent from a device and that is still in-transit. A record of this amount of data is maintained in a data counter at the device and is updated in response to data transmissions sent from the device and feedback signals received by the device. The feedback signals can indicate whether a data transmission was received at its destination, encountered congestion in the network, or was dropped by a network switch.

### CROSS-REFERENCE TO RELATED APPLICATIONS

This is the first application filed for the present invention.

### FIELD OF THE INVENTION

The present application pertains to communication networks and in particular to methods, apparatus, and systems for congestion control in communication networks.

### BACKGROUND

The traffic characteristics and bandwidth requirements of artificial intelligence (AI) applications are encouraging pursuit of lossy and packet-level load balancing schemes for use in data center networks (DCNs). In particular, AI applications can require switching capacities in excess of 100 Tbps. At these rates, the growth rate for the buffer of a switch in a DCN can lag behind the switch's switching capacity. Lossless network schemes, such as priority-based flow control (PFC) or credit-based flow control (CBFC) schemes, can require buffer sizes that vary linearly with switch capacity, thereby making these schemes unsustainable. Therefore, lossy schemes, in which intentional packet loss is introduced, are being pursued. In addition, AI applications can typically be low-entropy and include many large flows, which can lead to severe degradation in task completion time when flow collisions, such as from equal-cost multipath (ECMP) routing, occur. To minimize the impact of such flow collisions, packet-level load balancing is being pursued.

Despite the need for lossy and packet-level load balancing, currently available approaches are still inadequate. Approaches typically include using measurements of the round-trip time (RTT) in conjunction with explicit congestion notifications (ECNs) to signal congestion and adjust the transmission rate of senders accordingly. For example, approaches can involve senders comparing the RTT against expected values and reading ECN markings on acknowledgment signals (ACKs) to determine whether the sender's congestion window (CWND) should be increased or decreased. The reliance on measurements of the RTT typically makes these approaches overly complex or unstable. To measure the RTT, a sender can retain a timestamp for each packet sent, which adds overhead to the sender's buffer, or add the timestamp to the header of each packet, which plainly lengthens the packet header. In addition, measurement of the RTT can require the receiver to record delays due to processing thereat and to convey this information to the sender, which further adds overhead. Furthermore, the reliance on the RTT can punish some flows unfairly and cause those flows to starve. Currently available approaches can also overreact to congestion or fail to distinguish out-of-order or lost packets. These detriments can lead to unnecessary decreases in transmission rate and to underutilization of bandwidth.

Therefore, there is a need for a method and apparatus for lossy and packet-level load balancing that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for supporting lossy and packet-level load balancing.

A first aspect of the present disclosure is to provide a method to support transmission of data from a sender device to a receiver device through a communication network. The method may be performed at the sender device and comprise: preparing a data packet including at least one portion of the data and having associated thereto a size; sending, when the size of the data packet is less than or equal to a threshold, the data packet to the receiver device through the communication network, with the threshold depending from a value of a data counter representing an amount of in-transit data previously sent from the sender device; updating, when the data packet is sent, the value of the data counter in accordance with the size of the data packet; receiving, in response to sending the data packet, a feedback signal indicating, for the data packet, one outcome from among a set of outcomes, the set of outcomes including detection of congestion in the communication network; and updating the value of the data counter in accordance with the one outcome for the data packet.

In some embodiments of the first aspect, the set of outcomes may further include receipt of the at least one portion of the data by the receiver device. In some embodiments, the set of outcomes may further include discard of the at least one portion of the data.

In some embodiments of the first aspect, the threshold may comprise a difference comprised between a congestion window representing an instant maximum amount of in-transit data that can be sent from the sender device, and the value of the data counter. In some embodiments, the method may further comprise decreasing, when the one outcome is detection of congestion in the communication network, the congestion window in proportion to the size of the data packet. In some embodiments, the method may further comprise, updating, when the one outcome is detection of congestion in the communication network, the congestion window to a maximum of a pre-determined window minimum for the congestion window, and a further difference comprised between the congestion window and a product comprised between the size of the data packet and a weighting factor. In some embodiments, where the set of outcomes further includes receipt of the at least one portion of the data by the receiver device, the method may further comprise increasing, when the one outcome is receipt of the at least one portion of the data by the receiver device, the congestion window in proportion to the size of the data packet and in inverse proportion to the value of the data counter. In some embodiments, where the set of outcomes further includes receipt of the at least one portion of the data by the receiver device, the method may further comprise updating, when the one outcome is receipt of the at least one portion of the data by the receiver device, the congestion window to a minimum of a pre-determined window maximum for the congestion window, and a sum comprised between the congestion window and a product comprised between another weighting factor and a division comprised between the size of the data packet and the value of the data counter. In some embodiments, where the set of outcomes further includes discard of the at least one portion of the data, the method may further comprise decreasing, when the one outcome is discard of the at least one portion of the data, the congestion window by the size of the data packet. In some embodiments, where the set of outcomes further includes discard of the at least one portion of the data, the method may further comprise updating, when the one outcome is discard of the at least one portion of the data, the congestion window to a further maximum of the pre-determined window minimum for the congestion window and a still further difference comprised between the congestion window and the size of the data packet.

In some embodiments of the first aspect, updating, when the data packet is sent, the value of the data counter in accordance with the size of the data packet may include adding, when the data packet is sent, the size of the data packet to the value of the data counter. In some embodiments, updating the value of the data counter in accordance with the one outcome for the data packet may include setting the value of the data counter to a maximum of zero and a difference comprised between the value of the data counter and the size of the data packet.

In some embodiments of the first aspect, the feedback signal may further indicate the size of the data packet.

In some embodiments of the first aspect, when the one outcome is detection of congestion in the communication network, the feedback signal may be one of a congestion notification packet and an acknowledgment packet, and the feedback signal may be received from the receiver device.

In some embodiments of the first aspect, where the set of outcomes further includes receipt of the at least one portion of the data by the receiver device and when the one outcome is receipt of the at least one portion of the data by the receiver device, the feedback signal may be one of an acknowledgment packet and a selective acknowledgement packet, and the feedback signal may be received from the receiver device.

In some embodiments of the first aspect, where the set of outcomes further includes discard of the at least one portion of the data and when the one outcome is discard of the at least one portion of the data, the feedback signal may be a negative acknowledgment packet, and the feedback signal may be received from the receiver device.

In some embodiments of the first aspect, the data packet may include a header, the communication network may include a switch device, and the data packet may be sent to the receiver device through the switch device. In some embodiments, where the set of outcomes further includes discard of the at least one portion of the data and when the one outcome is discard of the at least one portion of the data, the feedback signal may consist of the header of the data packet, and the feedback signal may be received from the switch device.

A second aspect of the present disclosure is to provide another method to support transmission of data from a sender device to a receiver device through a communication network. The method may be performed at the receiver device and may comprise: receiving, from the sender device through the communication network, a data packet configured to include at least one portion of the data and a congestion indicator indicating congestion in the communication network; inspecting the data packet to identify one or more outcomes, with the one or more outcomes including receipt of the at least one portion of the data when the data packet includes the at least one portion of the data and detection of congestion in the communication network when the data packet includes the congestion indicator; and sending, in response to receiving the data packet, a feedback signal to the sender, the feedback signal indicating the one or more outcomes.

In some embodiments of the second aspect, the data packet may include a header, and the one or more outcomes may further include discard of the at least one portion of the data when the data packet consists of the header. In some embodiments, the congestion indicator may be an explicit congestion notification. In some embodiments, the feedback signal may be one of a congestion notification packet and an acknowledgment packet when the one or more outcomes includes detection of congestion in the communication network. In some embodiments, the feedback signal may be one of a negative acknowledgment packet and the data packet when the one or more outcomes includes discard of the at least one portion of the data. In some embodiments, the feedback signal may be one of an acknowledgment packet and a selective acknowledgment packet when the one or more outcomes includes receipt of the at least one portion of the data.

In some embodiments of the second aspect, the data packet may have associated thereto a size, and the feedback signal may include the size of the data packet.

A third aspect of the present disclosure is to provide, a method to support transmission of data from a sender device to a receiver device through a communication network including a switch device. The method may be performed by the switch device and may comprise: receiving, from the sender device through the communication network, a data packet including a header and at least one portion of the data, with the data packet further configured to include a congestion indicator; performing a first set of actions when one or more pre-determined congestion criteria are met, with the first set of actions including modifying the data packet to include the congestion indicator and sending the data packet to the receiver device through the communication network; and performing a second set of actions when one or more pre-determined discard criteria are met, the second set of actions including discarding the at least one portion of the data to produce a trimmed data packet consisting of the header of the data packet and sending the trimmed data packet to at least one of the sender device and the receiver device through the communication network.

In some embodiments of the third aspect, the congestion indicator may be an explicit congestion notification.

A fourth aspect of the present disclosure is to provide a communication network comprising a receiver device and a sender device connected to the receiver device. The sender device may be configured to: prepare a data packet including data and having associated thereto a size; send, when the size of the data packet is less than or equal to a threshold, the data packet to the receiver device, with the threshold depending from a value of a data counter representing an amount of in-transit data previously sent from the sender device; update, when the data packet is sent, the value of the data counter in accordance with the size of the data packet; receive, in response to sending the data packet, a feedback signal indicating, for the data packet, one outcome from among a set of outcomes, with the set of outcomes including detection of congestion in the communication network; and update the value of the data counter in accordance with the one outcome for the data packet.

In some embodiments of the fourth aspect, the data packet may be configured to include a congestion indicator, and the set of outcomes may further include receipt of the at least one portion of the data. In these embodiments, the receiver device may be configured to: receive, from the sender device, the data packet; inspect the data packet to identify the one outcome to be receipt of the at least one portion of the data when the data is included in the received data packet and detection of congestion in the communication network when the data packet includes the congestion indicator; and send, in response to receiving the data packet, the feedback signal to the sender.

In some embodiments of the fourth aspect, the data packet may include a header and may be configured to include a congestion indicator. In these embodiments, the communication network may further comprise a switch device connecting the sender device to the receiver device. The switch device may be configured to: receive, from the sender device, the data packet; perform a first set of actions when one or more pre-determined congestion criteria are met, with the first set of actions including modifying the data packet to include the congestion indicator, and sending the data packet to the receiver device; and perform a second set of actions when one or more pre-determined discard criteria are met, with the second set of actions including discarding the data to produce a trimmed data packet consisting of the header of the data packet, and sending the trimmed data packet to at least one of the sender device and the receiver device.

Embodiments of the first aspect may enable lossy and packet-level load-balancing in communication networks, especially for AI applications. Embodiments may facilitate accurate control of transmission rates and rapid convergence of transmission rates when congestion arises.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows a plot of bandwidth utilization ratio versus oversubscription ratio for typical packet-level and flow-level schemes when load balancing an exemplary AI application.

FIG. 1B shows a plot of typical buffer size per switch capacity for various switch capacities.

FIG. 2 shows a flowchart of a method for a sender device in transmitting data to a receiver device, in accordance with embodiments of the present disclosure.

FIG. 3 shows a flowchart of a method for a switch and a receiver device to provide feedback signals to a sender device, in accordance with embodiments of the present disclosure.

FIG. 4 shows a schematic of an example communication network in which embodiments of the present disclosure may be implemented.

FIG. 5 shows a schematic of another example communication network in which embodiments of the present disclosure may be implemented.

FIG. 6 shows a schematic of an apparatus for load balancing according to embodiments of the present disclosure.

FIG. 7 shows a schematic of an embodiment of an electronic device that may implement at least part of the methods and features of the present disclosure.

It will be noted that throughout the appended drawings, like features are identified by like reference numerals.

### DETAILED DESCRIPTION

To facilitate lossy and packet-level load balancing in a communication network, especially for AI applications, embodiments of the present disclosure are generally directed towards regulating the transmission rate of devices in the network to control congestion according to the number of in-transit packets sent from the devices. In embodiments, a device transmitting data (i.e., a sender device) through the communication network may send a packet of the data when the size of that packet is less than or equal to a threshold. The threshold may depend on a value of a data counter that records the amount of data that has been sent from the sender device and that is still in-transit (or at least has not been confirmed to have been received or dropped). When the data packet is sent, the sender device may update the value of the data counter according to the size of the packet. In addition, when the sender device receives feedback signals on the transmission, which may indicate an outcome for the packet, such as whether it was received, dropped, or encountered congestion, the sender device may also update the value of the data counter accordingly. In some embodiments, the threshold for sending the data packet may also depend on a congestion window, which may also be updated according to the respective outcome for each packet sent. In embodiments, the feedback signals received by the sender device may be prepared and sent by the intended receiver of the data packet (i.e., the receiver device) and/or switches in the communication network.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof.

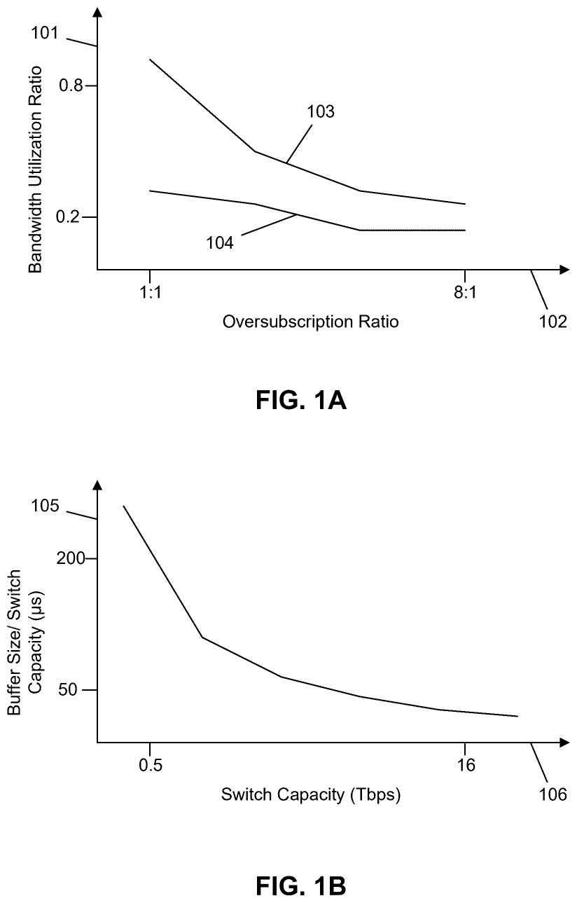

FIG. 1A shows a plot of bandwidth utilization ratio 101 versus oversubscription ratio 102 for typical packet-level 103 and flow-level 104 schemes when load balancing an exemplary AI application on 64 nodes of a computing network. The plot shows that the packet-level scheme 103 has superior bandwidth utilization over the flow-level scheme 104, demonstrating that the packet-level scheme 103, handles the low-entropy characteristics of AI traffic better and avoids ECMP collisions better. FIG. 1B shows a plot of buffer size per switch capacity 105 (in microseconds) for various switch capacities 106 (in terabits-per-second). The plot shows that the switch buffer cannot grow sufficiently fast to accommodate increases in switch capacity, demonstrating that lossless load balancing is unsustainable for the high switch capacities needed for AI applications. The results shown in FIG. 1A and FIG. 1B indicate that lossy and packet-level schemes are needed for efficiently load-balancing AI applications. However, as described hereinabove, current approaches to lossy and packet-level load balancing are overly complex and unstable, or harm transmission rate and underutilize bandwidth.

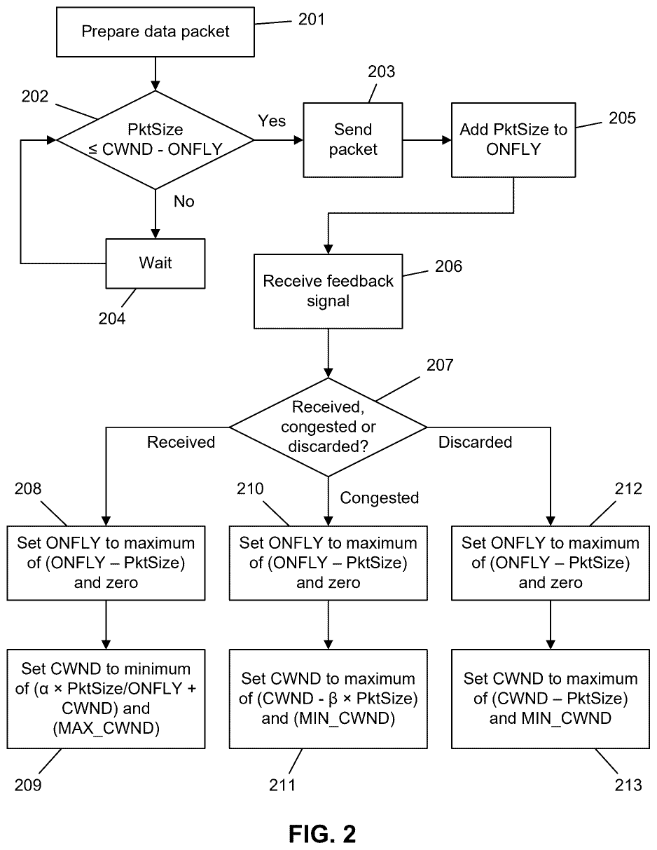

FIG. 2 shows a method for supporting transmission of data from a sender device to a receiver device through a communication network, in accordance with embodiments of the present disclosure. The method may be implemented as part of a congestion control scheme for lossy and packet-level load balancing. Congestion may refer to a build up of data flowing through the communication network such that the amount of data exceeds the capacity of the communication network for processing the data. It may manifest, for example, as an accumulation of data in the queues or buffers of network devices or a reduction in the throughput of the network. Each of the sender device and the receiver device may be configured to transmit and/or receive data, and may be categorized as a ‘sender’ or ‘receiver’ depending on whether they are presently transmitting or receiving the data. Each of the sender device and the receiver device may include a network interface card (NIC) or similar hardware for transmitting and receiving data. The sender device and the receiver device may be connected through one or more links of the communication network, which may each include one or more switches (i.e., ‘switch devices’). The communication network may, for example, be a DCN or a distributed computing network.

To transmit data from the sender device to the receiver device, the sender device may first, at action 201, prepare a data packet that includes some of the data. The data packet may be a unit of digital transmission providing at least a portion of the data as, for example, a payload. The data packet may have a size (PktSize) associated thereto. The sender device, at action 202, may then compare the size of the data packet to a threshold. The threshold may depend from a value of a data counter (ONFLY) that represents an amount of in-transit data previously sent from the sender device. The data counter may be a variable stored in a memory at the sender device and may be updated according to the present method. The threshold may further depend from a congestion window (CWND) that can be dynamically adjusted and that represents an instant amount of in-transit data that can be sent from the sender device, where instant amount may refer to the amount allowable at the present moment. The congestion window may be a variable stored in the memory at the sender device. The congestion window may further represent the instant amount of in-transit data that can be sent from the sender device and that is within the capacity of the communication network to process. The threshold may comprise a difference between the congestion window and the value of the data counter (i.e., CWND−ONFLY), and comparison of the size of the data packet to the threshold may involve evaluating whether the size of the data packet is less than the threshold (i.e., is PktSize<CWND−ONFLY true?). A person of skill in the art will appreciate that this comparison may be formulated differently in different embodiments. If the size of the data packet is less than the threshold, the sender device may, at action 203, send the data packet to the receiver device through the communication network. However, if the size of the data packet is greater than the threshold, the sender device may, at action 204, wait a pre-determined duration before re-evaluating the comparison of action 202. In some embodiments, the data packet may further be sent to the receiver device if the size of the data packet is equal to the threshold (i.e., is PktSize≤CWND−ONFLY true?).

The sender device may have a pre-determined window minimum (MIN_CWND) and window maximum (MAX_CWND) for the congestion window. The congestion window may be initialized to the value of the pre-determined window maximum, and the value of the data counter may be initialized to zero prior to any data being sent. In embodiments of the present disclosure, in-transit data may mean data that has been sent from the sender device but for which no feedback signal has been received, such as to confirm whether the data has been received or dropped. In other words, in-transit data may refer to the sender device's understanding of what data is on route or on-the-fly to the receiver device. A feedback signal may be any notification or message received by the sender device that indicates an outcome for the sent data packet, such as its reception by the receiver device.

At action 205, when the data packet is sent, the sender device may update the value of the data counter in accordance with the size of the data packet. This may include adding the size of the data packet to the value of the data counter (e.g., ONFLY+=PktSize). Updating the value of the data counter may therefore change the threshold against which future data packets to be sent from the sender device are compared. This may then contribute to a regulation of transmissions from the sender device.

At action 206, the sender device may receive, in response to sending the data packet, a feedback signal that indicates an outcome for the data packet. The outcome may be one of a set of outcomes, which may include: receipt, by the receiver device, of the data included in the data packet; discard or dropping of the data included in the data packet; and detection of congestion in the communication network. The aforementioned outcomes may respectively be indicated by ‘RECEIVED’, ‘DISCARDED’, and ‘CONGESTED’ feedback signals. The RECEIVED signal may be generated and sent by the receiver device. The DISCARDED signal may be produced and sent from a switch or the receiver device in response to the data being dropped by a switch in the communications network or by the receiver device. The CONGESTED signal may further indicate receipt, by the receiver device, of the data included in the data packet, in addition to indicating detection of congestion. In this case, the RECEIVED signal may further indicate that congestion was not detected. Each feedback signal may indicate the size of the packet for the data packet that the signal is reporting an outcome towards.

At action 207, the sender device may inspect the feedback signal to determine the outcome for the data packet. The sender device may then update the value of the data counter in accordance with the determined outcome. The sender device may further update the congestion window in accordance with the determined outcome.

If the feedback signal is a RECEIVED signal that indicates the data included in the data packet was received by the receiver device, the sender device may, at action 208, update the value of the data counter by subtracting the size of the data packet from the value of the data counter, down to a minimum of zero (e.g., ONFLY=max(ONFLY−PktSize, 0)). At action 209, the sender device may further update the congestion window by increasing the congestion window by an amount that is proportional to the size of the data packet and inversely proportional to the current value of the data counter, up to the pre-determined window maximum. In other words, the sender device may set the congestion window to a minimum of the pre-determined window maximum and a sum comprised between the current congestion window and a product of a first weighting factor (α) and a division between the size of the data packet and the value of the data counter (e.g., CWND=min(MAX_CWND, α×PktSize/ONFLY+CWND)). The first weighting factor may, for example, be a pre-determined value less than or equal to one, or may be dynamically adjusted.

If the feedback signal is a CONGESTED signal that indicates the data included in the data packet was received by the receiver device and that congestion was detected in the communication network, the sender device may, at action 210, update the value of the data counter by subtracting the size of the data packet from the value of the data counter, down to a minimum of zero (e.g., ONFLY=max(ONFLY−PktSize, 0)). At action 211, the sender device may further update the congestion window by decreasing the congestion window by an amount that is proportional to the size of the data packet, down to the pre-determined window minimum. In other words, the sender device may set the congestion window to a maximum of the pre-determined window minimum and a difference of the congestion window and a product of a second weighting factor (β) and the size of the data packet (e.g., CWND=max(MIN_CWND, CWND−β×PktSize)). The second weighting factor may, for example, be a pre-determined value less than or equal to one, or may be dynamically adjusted.

If the feedback signal is a DISCARDED signal that indicates the data included in the data packet was discarded before it could be received by the receiver device, the sender device may, at action 212, update the value of the data counter by subtracting the size of the data packet from the value of the data counter, down to a minimum of zero (e.g., ONFLY=max(ONFLY−PktSize, 0)). At action 213, the sender device may further update the congestion window by decreasing the congestion window by an amount that is identical to the size of the data packet, down to the pre-determined window minimum. In other words, the sender device may set the congestion window to a maximum of the pre-determined window minimum and a difference of the congestion window and the size of the data packet (e.g., CWND=max(MIN_CWND, CWND−PktSize)).

Updating the value of the data counter and the congestion window in response to received feedback signals may change the threshold against which future data packets to be sent from the sender device are compared. This may further contribute to a regulation of transmissions from the sender device.

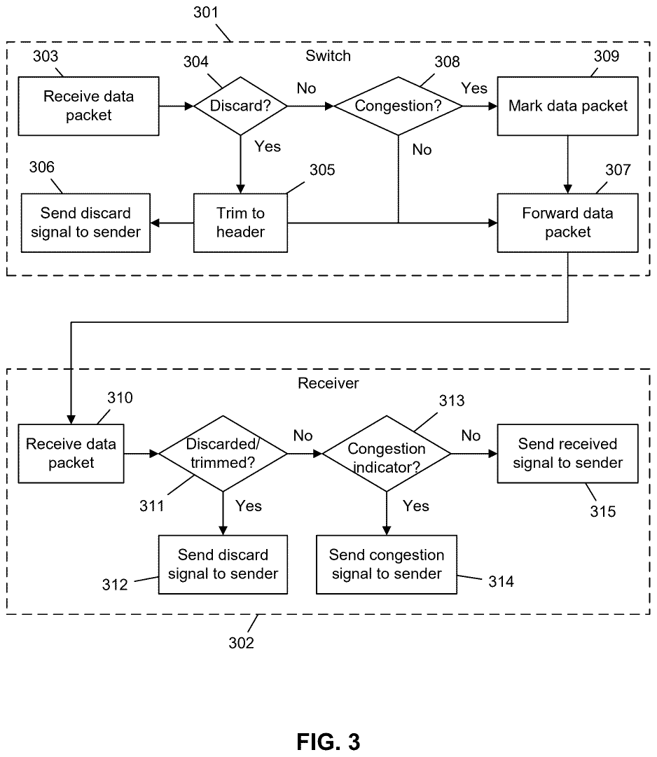

FIG. 3 shows another method for supporting transmission of data from a sender device to a receiver device through a communication network, in accordance with embodiments of the present disclosure. The method may be implemented as part of a congestion control scheme for lossy and packet-level load balancing. The method may be implemented, at least in part, by one or more switches 301 in the communication network and the receiver device 302. Each switch 301 may be located along a link connecting the sender device to the receiver device 302 and through which the data is transmitted. The method may be used for providing feedback signals to the sender device.

At action 303, a switch 301 may receive a data packet from the sender device through the communication network. The data packet may include a header and at least one portion of the data to be sent from the sender device to the receiver device. At action 304, the switch 301 may evaluate whether the data included in the data packet should be discarded. The switch 301 may discard the data if one or more pre-determined criteria are met (i.e., ‘pre-determined discard criteria’). Criteria may, for example, include an amount of available space in a buffer of the switch 301 diminishing to a pre-determined threshold for buffer space. At action 305, the switch 301 may produce a feedback signal to indicate the discard of the data (i.e., a DISCARDED signal). The feedback signal may, for example, be the data packet with the data payload discarded. In other words, the feedback signal may be the data packet trimmed to consist only of the header (i.e., a ‘trimmed data packet’). The header may include the size of the data packet. The switch 301 may send the trimmed data packet to at least one of the sender device, at action 306, or the receiver device 302, at action 307.

If the pre-determined discard criteria are not met, the switch 301 may, at action 308, evaluate the state of its local congestion. The switch 301 may, at action, 309, mark or modify the data packet to include a congestion indicator if one or more pre-determined criteria are met (i.e., ‘pre-determined congestion criteria’). Examples of criteria may, for example, include a length of a queue at the switch 301 exceeding a pre-determined threshold for queue length. The congestion indicator may be a pre-determined setting for a particular field of the data packet, such as in the header of the data packet, that indicates congestion has been detected in the communication network. For example, the congestion indicator may be an explicit congestion notification (ECN), provided by an ECN field of the header, which may be marked, for example, as “2b'11”. At action 307, the switch 301 may send the data packet, marked or unmarked with the congestion indicator, to the receiver device 302 through the communication network.

Actions 303 to 309 may be performed by each switch 301 along the link between the sender device and receiver device 302 through which the data packet is sent.

At action 310, the receiver device 302 may receive the data packet. The receiver device 302 may then inspect the data packet to identify one or more outcomes for the packet. The outcomes may be selected from a set of outcomes, as described in relation to FIG. 2. At action 311, the receiver device 302 may evaluate whether the data packet has been trimmed and thus indicates that the data included in the data packet has been discarded by a switch 301. If the data packet includes the data, the receiver device 302 may evaluate whether the data included in the data packet should be discarded by the receiver device 302 itself. The receiver device 302 may discard the data if one or more pre-determined criteria are met for the receiver device 302. Criteria may, for example, include an amount of available space in a buffer of the receiver device 302 diminishing to a pre-determined threshold for buffer space. If the receiver device 302 determines that the data has been discarded or discards the data itself, it may send, at action 312, a corresponding feedback signal (i.e., a DISCARDED signal) to the sender device. The DISCARDED signal may be, for example, a negative acknowledgement (NACK) packet or the trimmed data packet itself. The DISCARDED signal may indicate the size of the data packet. At action 313, if the receiver device 302 determines that the data has not been discarded and does not discard the data itself, the receiver device 302 may evaluate whether the data packet indicates congestion in the communication network, such as through the inclusion of a congestion indicator. If the receiver device 302 identifies a congestion indicator, it may send, at action 314, a corresponding feedback signal (i.e., a CONGESTED signal) to the sender device. The CONGESTED signal may be, for example, a congestion notification packet (CNP) or an acknowledgement (ACK) packet with a respective congestion indicator. The CONGESTED signal may indicate the size of the data packet. If the receiver device 302 does not identify a congestion indicator and that the data has not been discarded, it may send, at action 315, a corresponding feedback signal (i.e., a RECEIVED signal) to the sender device. The RECEIVED signal may, for example, be an ACK packet or a selective acknowledgement (SACK) packet. The RECEIVED signal may also indicate the size of the data packet.

In some embodiments, wherein a PFC or CBFC scheme is used, data may not be discarded. In these embodiments, the RECEIVED and CONGESTED signals may still be used, in accordance with actions 313 to 315. In some embodiments, the RECEIVED signal may be delayed, at action 315, and modified to indicate receipt of a plurality of data packets sent from the sender device.

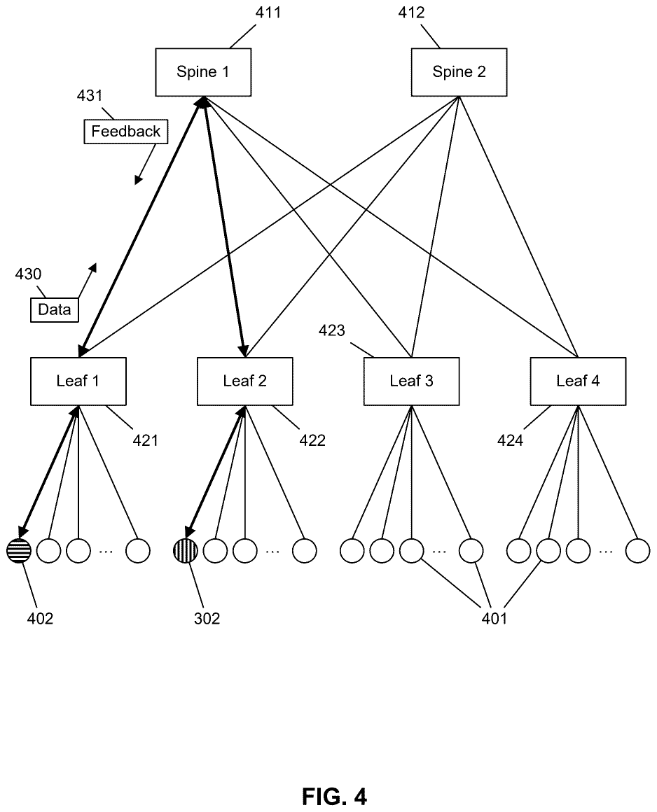

FIG. 4 shows a schematic of an exemplary communication network in which embodiments of the present disclosure may be implemented. The communication network comprises a plurality of network devices 401 connected by a plurality of switches 301. Each network device 401 may host an AI application. Among the network devices 401 is a sender device 402 (indicated by horizontal stripes) that intends to transmit data to a receiver device 302 (indicated by vertical stripes) also among the network devices 401. The plurality of switches are arranged to form a two-layer clos network and comprise a first spine switch 411 (spine 1), a second spine switch 412 (spine 2), a first leaf switch 421 (leaf 1), a second leaf switch 422 (leaf 2), a third leaf switch 423 (leaf 3), and a fourth leaf switch 424 (leaf 4). The sender device 402 may send a data packet 430 of the data to the receiver device 302 in accordance with the method described in relation to FIG. 2. The data packet may be sent to the receiver device 302 through, for example, the first leaf switch 421, the first spine switch 411, and the second leaf switch 422 (as indicated by the bold-face connections in FIG. 4). In response, one of these switches or the receiver device 302 may send a feedback signal 431 to the sender device 402 in accordance with the method described in relation to FIG. 3.

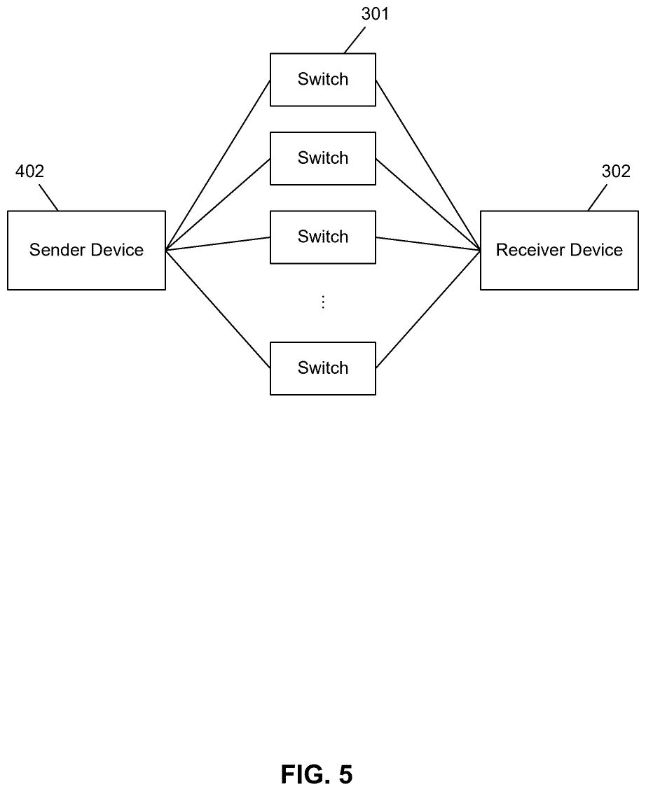

FIG. 5 shows a schematic of another exemplary communication network in which embodiments of the present disclosure may be implemented. The communication network comprises a sender device 402 connected to a receiver device 302 by a plurality of switches 301. In this example, the plurality of switches 301 are arranged to form a single hop between the sender device 402 and the receiver device 302. The sender device 402 may send a data packet 430 of the data to the receiver device 302 in accordance with the method described in relation to FIG. 2. The data packet may be sent to the receiver device 302 through one of the plurality of switches 301. In response, the one switch 301 or the receiver device 302 may send a feedback signal 431 to the sender device 402 in accordance with the method described in relation to FIG. 3.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

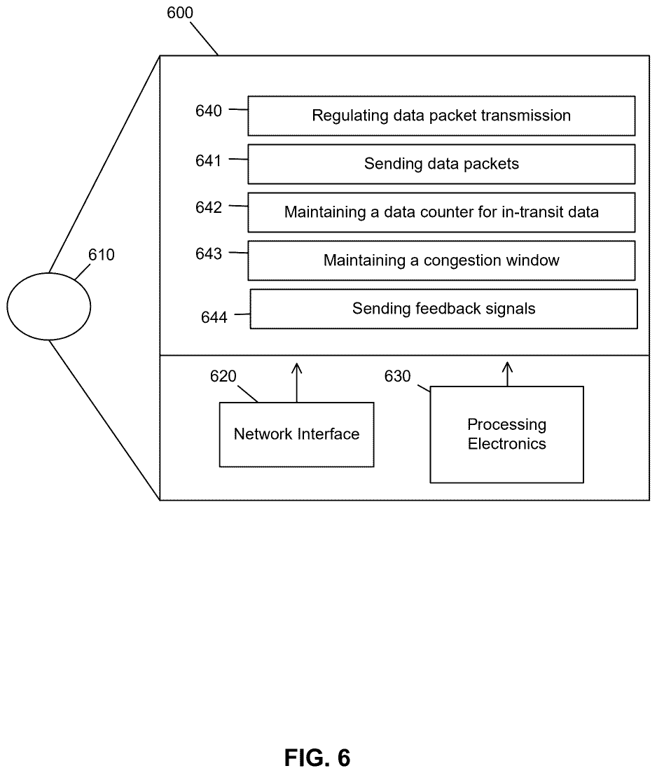

FIG. 6 shows an apparatus 600 for load balancing in a communication network, according to embodiments of the present disclosure. The apparatus 600 may be located at a node 610 of the network. The apparatus may include a network interface 620 and processing electronics 630. The processing electronics 630 may include a computer processor executing program instructions stored in memory, or other electronics components such as digital circuitry, including for example FPGAs and ASICs. The network interface 620 may include an optical communication interface or radio communication interface, such as a transmitter and receiver. The apparatus 600 may include several functional components, each of which may be partially or fully implemented using the underlying network interface 620 and processing electronics 630. Examples of functional components may include modules for regulating 640 data packet transmission, sending 641 data packets, maintaining 642 a data counter for in-transit data, maintaining 643 a congestion window, and sending 644 feedback signals.

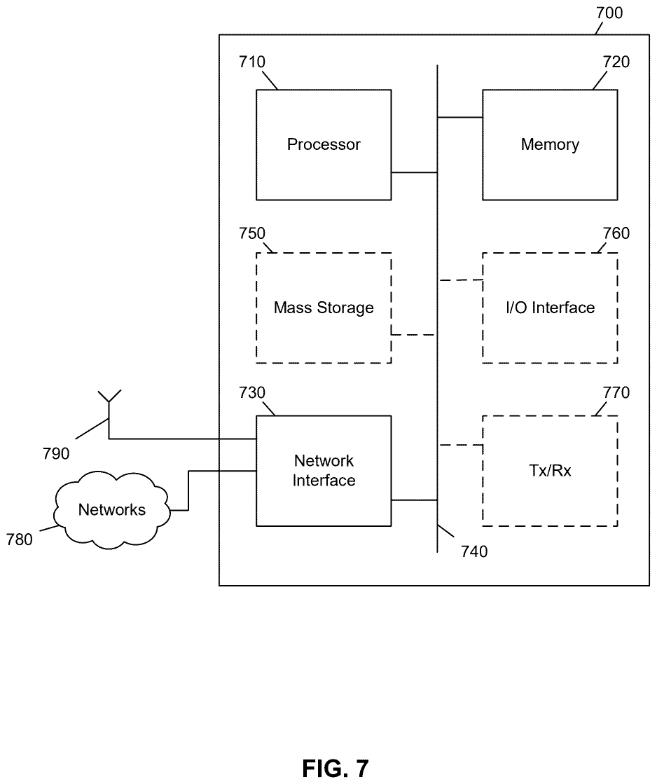

FIG. 7 shows a schematic diagram of an electronic device 700 that may perform any or all of the operations of the above methods and features explicitly or implicitly described herein, according to different embodiments of the present disclosure. For example, a computer equipped with network function may be configured as electronic device 700. The electronic device 700 may be used to implement the apparatus 600 of FIG. 6, for example. The electronic device 700 may further be used as part of a sender device 402, a switch 301, or a receiver device 302 for example.

As shown, the electronic device 700 may include a processor 710, such as a central processing unit (CPU) or specialized processors such as a graphics processing unit (GPU) or other such processor unit, memory 720, network interface 730, and a bi-directional bus 740 to communicatively couple the components of electronic device 700. Electronic device 700 may also optionally include non-transitory mass storage 750, an I/O interface 760, and a transceiver 770. According to certain embodiments, any or all of the depicted elements may be utilized, or only a subset of the elements. Further, the electronic device 700 may contain multiple instances of certain elements, such as multiple processors, memories, or transceivers. Also, elements of the hardware device may be directly coupled to other elements without the bi-directional bus 740. Additionally or alternatively to a processor and memory, other electronics, such as integrated circuits, may be employed for performing the required logical operations.

The memory 720 may include any type of tangible, non-transitory memory such as static random access memory (SRAM), dynamic random access memory (DRAM), synchronous DRAM (SDRAM), read-only memory (ROM), any combination of such, or the like. The mass storage element 750 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 720 or mass storage 750 may have recorded thereon statements and instructions executable by the processor 710 for performing any of the aforementioned method operations described above.

Network interface 730 may include at least one of a wired network interface and a wireless network interface. The network interface 730 may include a wired network interface to connect to a communication network 780 and may also include a radio access network interface 790 for connecting to the communication network 780 or other network elements over a radio link. The network interface 730 enables the electronic device 700 to communicate with remote entities such as those connected to the communication network 780.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method to support transmission of data from a sender device to a receiver device through a communication network, the method comprising, at the sender device:
preparing a data packet including at least one portion of the data and having associated thereto a size;
sending, when the size of the data packet is less than or equal to a threshold, the data packet to the receiver device through the communication network, the threshold depending from a value of a data counter representing an amount of in-transit data previously sent from the sender device;
updating, when the data packet is sent, the value of the register in accordance with the size of the data packet;
receiving, in response to sending the data packet, a feedback signal indicating, for the data packet, one outcome from among a set of outcomes, the set of outcomes including detection of congestion in the communication network;
and
updating the value of the data counter in accordance with the one outcome for the data packet.

2. The method of claim 1 wherein the set of outcomes further includes receipt of the at least one portion of the data by the receiver device.

3. The method of claim 1 wherein the set of outcomes further includes discard of the at least one portion of the data.

4. The method of claim 1 wherein the threshold comprises a difference comprised between:
a congestion window representing an instant maximum amount of in-transit data that can be sent from the sender device,
and
the value of the data counter.

5. The method of claim 1 wherein updating, when the data packet is sent, the value of the data counter in accordance with the size of the data packet includes:
adding, when the data packet is sent, the size of the data packet to the value of the data counter.

6. The method of claim 1 wherein updating the value of the data counter in accordance with the one outcome for the data packet includes:
setting the value of the data counter to a maximum of zero and a difference comprised between the value of the data counter and the size of the data packet.

7. The method of claim 4 further comprising, at the sender device:
decreasing, when the one outcome is detection of congestion in the communication network, the congestion window in proportion to the size of the data packet.

8. The method of claim 4 further comprising, at the sender device:
updating, when the one outcome is detection of congestion in the communication network, the congestion window to a maximum of:
a pre-determined window minimum for the congestion window,
and
a further difference comprised between:
the congestion window,
and
a product comprised between the size of the data packet and a weighting factor.

9. The method of claim 4 wherein:
the set of outcomes further includes receipt of the at least one portion of the data by the receiver device;
and
the method further comprises, at the sender device:
increasing, when the one outcome is receipt of the at least one portion of the data by the receiver device, the congestion window in proportion to the size of the data packet and in inverse proportion to the value of the data counter.

10. The method of claim 4 wherein:
the set of outcomes further includes receipt of the at least one portion of the data by the receiver device;
and
the method further comprises, at the sender device:
updating, when the one outcome is receipt of the at least one portion of the data by the receiver device, the congestion window to a minimum of:
a pre-determined window maximum for the congestion window,
and
a sum comprised between:
the congestion window,
and
a product comprised between:
a weighting factor,
and
a division comprised between the size of the data packet and the value of the data counter.

11. The method of claim 4 wherein:
the set of outcomes further includes discard of the at least one portion of the data;
and
the method further comprises, at the sender device:
decreasing, when the one outcome is discard of the at least one portion of the data, the congestion window by the size of the data packet.

12. The method of claim 4 wherein:
the set of outcomes further includes discard of the at least one portion of the data;
and
the method further comprises, at the sender device:
updating, when the one outcome is discard of the at least one portion of the data, the congestion window to a maximum of:
a pre-determined window minimum for the congestion window,
and
a further difference comprised between the congestion window and the size of the data packet.

13. The method of claim 1 wherein the feedback signal further indicates the size of the data packet.

14. The method of claim 1 wherein, when the one outcome is detection of congestion in the communication network:
the feedback signal is one of a congestion notification packet and an acknowledgment packet;
and
the feedback signal is received from the receiver device.

15. The method of claim 2 wherein, when the one outcome is receipt of the at least one portion of the data by the receiver device:
the feedback signal is one of an acknowledgment packet and a selective acknowledgement packet;
and
the feedback signal is received from the receiver device.

16. The method of claim 3 wherein, when the one outcome is discard of the at least one portion of the data:
the feedback signal is a negative acknowledgment packet;
and
the feedback signal is received from the receiver device.

17. The method of claim 3 wherein:
the data packet includes a header;
the communication network includes a switch device;
the data packet is sent to the receiver device through the switch device;
and
when the one outcome is discard of the at least one portion of the data:
the feedback signal consists of the header of the data packet;
and
the feedback signal is received from the switch device.

18. A method to support transmission of data from a sender device to a receiver device through a communication network, the method comprising, at the receiver device:
receiving, from the sender device through the communication network, a data packet configured to include at least one portion of the data and a congestion indicator indicating congestion in the communication network;
inspecting the data packet to identify one or more outcomes, the one or more outcomes including:
receipt of the at least one portion of the data when the data packet includes the at least one portion of the data,
and
detection of congestion in the communication network when the data packet includes the congestion indicator;
and
sending, in response to receiving the data packet, a feedback signal to the sender, the feedback signal indicating the one or more outcomes.

19. The method of claim 18 wherein:
the data packet includes a header;
and
the one or more outcomes further includes discard of the at least one portion of the data when the data packet consists of the header.

20. A method to support transmission of data from a sender device to a receiver device through a communication network including a switch device, the method comprising, at the switch device:
receiving, from the sender device through the communication network, a data packet including a header and at least one portion of the data, the data packet further configured to include a congestion indicator;
performing a first set of actions when one or more pre-determined congestion criteria are met, the first set of actions including:
modifying the data packet to include the congestion indicator,
and
sending the data packet to the receiver device through the communication network;
and
performing a second set of actions when one or more pre-determined discard criteria are met, the second set of actions including:
discarding the at least one portion of the data to produce a trimmed data packet consisting of the header of the data packet,
and
sending the trimmed data packet to at least one of the sender device and the receiver device through the communication network.
